(19) United States
(12) Patent Application Publication
(10) Pub. No.: US 2013/0308546 A1
(43) Pub. Date: Nov. 21, 2013

(54) MOBILE STATION, COMMUNICATION APPLICATION, AND MOBILE COMMUNICATION METHOD

(71) Applicants: Shin Naraha, Tokyo (JP); Koichiro Kunitomo, Tokyo (JP); Katsutoshi Nishida, Tokyo (JP)

(72) Inventors: Shin Naraha, Tokyo (JP); Koichiro Kunitomo, Tokyo (JP); Katsutoshi Nishida, Tokyo (JP)

(73) Assignee: NTT DOCOMO, INC., Tokyo (JP)

(21) Appl. No.: 13/983,087

(22) PCT Filed: Feb. 8, 2012
(86) PCT No.: PCT/JP2012/052867

§ 371 Date: Aug. 1, 2013

(30) Foreign Application Priority Data
Feb. 9, 2011 (JP) 2011-026584

(51) Int. Cl. H04W 68/00

(52) U.S. Cl. CPC H04W 68/00
USPC 370/328

(57) ABSTRACT

A communication application is caused to be capable of receiving a “RA” before “Router lifetime” expires, while avoiding waste of radio resources, waste of a battery of a mobile station UE or an externally-connected apparatus, or network processing required for the mobile station UE to transition between an “IDLE state” and an “ACTIVE” state. The mobile station UE according to the invention includes a RA reception unit configured to receive a “RA” from the network and a RA transmission unit 12 configured to transmit a “RA#1” to the communication application 20 when the “RA#1” is received by the RA reception unit 11. The RA transmission unit 12 is configured to retransmit the “RA#1” to the communication application 20 before the “Router lifetime” in the communication application expires even when a “RA#2” is not re-received by the RA reception unit 11.

### TECHNICAL FIELD

The present invention relates to a mobile station, a communication application, and a mobile communication method.

### BACKGROUND ART

According to the specifications of Non-patent document 1, a communication application which is activated on an externally-connected apparatus such as a mobile station UE (User Equipment) and a PC (Personal Computer) connectable with the mobile station UE is configured such that when receiving “RA (Router Advertisement, a router notification signal),” the communication application sets “Router lifetime (predetermined timer)” and holds “default gateway information (packet transfer information)” contained in the “RA.”

In addition, the communication application is configured such that when the “RA” is received before the “Router lifetime” expires, the communication application updates the validity of a held IPv6 address and then updates the “default gateway information” based on the received “RA.”

On the other hand, the communication application is configured such that when it is determined that the IPv6 address is invalid, in other words, when the “RA” is not received before the “Router lifetime” expires, the communication application deletes the “default gateway information.”

In other words, the communication application is configured to hold the “default gateway information” until the “Router lifetime (e.g., 18 hours) ” notified by the “RA” expires and delete the “default gateway information” after the “Router lifetime” has expired.

Note that the “RA” is a signal which notifies “IPv6 Prefix” to be assigned to the communication application, “Router lifetime” indicating a time period during which the “IPv6 Prefix” is valid, or “default gateway information” of packet transfer information for the communication application.

Here, the “Router lifetime” is a timer which is held by the communication application, and a time period three times longer than “MaxRtrAdvInterval (timer on a network side)” is defined as a default value (see, for example, Non-patent document 1).

In addition, the “MaxRtrAdvInterval” is a timer (maximum RA transmission interval) which is held by S-GW (Serving Gateway) or P-GW (PDN Gateway) with which the mobile station UE is connected, and “21600 seconds (6 hours)” is defined as a default value (see, for example, Non-patent document 2).

### PRIOR ART DOCUMENT

### Non-Patent Document

Non-patent document 1: RFC 4861 6.2.1

Non-patent document 2: 3GPP TS29.061

### SUMMARY OF THE INVENTION

However, in a conventional mobile communication system, a mobile station UE has to transmit a “RA” to a communication application before a “Router lifetime” expires, and thus even when there is no need to perform communications between networks, the mobile station UE has to periodically transition from an “IDLE state” to an “ACTIVE state” in order to receive the “RA” from the networks. As a result, there is a problem in that a radio resource is wasted, a battery of a mobile station UE or an externally-connected apparatus is wasted, or network processing required for transition between the “IDLE state” and the “ACTIVE state” is caused.

For this reason, the present invention is made in view of the above-described problems. Accordingly, an objective of the present invention is to provide a mobile station, a communication application, and a mobile communication method in which a communication application is caused to be capable of receiving a “RA” before “Router lifetime” expires, while avoiding the waste of radio resources, the waste of a battery of the mobile station UE or externally-connected apparatus, and the network processing required for the mobile station UE to transition between an “IDLE state” and an “ACTIVE” state.

A first feature of the present invention is a mobile station capable of communicating with a communication application configured to set a predetermined timer and hold packet transfer information contained in a notification signal when the notification signal is received, and to delete the held packet transfer information when a notification signal is not re-received before the predetermined timer expires, the mobile station including: a notification signal reception unit configured to receive a notification signal from a network; and a notification signal transmission unit configured to transmit a first notification signal to the communication application when the first notification signal is received by the notification signal reception unit, in which the notification signal transmission unit is configured to retransmit the first notification signal to the communication application even when a second notification signal is not re-received by the notification signal reception unit before the predetermined timer in the communication application expires.

A second feature of the present invention is a communication application configured to set a predetermined timer and hold packet transfer information contained in a notification signal when the notification signal is received via a mobile station, and to delete the held packet transfer information when a notification signal is not re-received before the predetermined timer expires, the communication application including: a transmission unit configured to transmit a packet communication originating request signal to the mobile station when the predetermined timer has expired even when a packet to be transmitted is absent.

A third feature of the present invention is a mobile communication method in a mobile communication system including a network, a mobile station, and a communication application, in which the communication application is configured to set a predetermined timer and hold packet transfer information contained in a notification signal when the notification signal is received via a mobile station, and to delete the held packet transfer information when a notification signal is not re-received before the predetermined timer expires, the mobile communication method including: a step A of transmitting, by the communication application, a packet communication originating request signal to the mobile station when the predetermined timer has expired even when a packet to be transmitted is absent; a step B of transmitting, by the mobile station, a service request signal to the network in an idle state; a step C of transmitting, by the network, a notification signal to the mobile station in response to the service request signal; and a step D of transmitting, by the mobile station, the received notification signal to the communication application.

### BRIEF DESCRIPTION OF DRAWINGS

FIG. 1 is an overall configuration diagram of a mobile communication system according to a first embodiment of the invention.

FIG. 2 is a functional block diagram of the mobile communication system according to the first embodiment of the invention.

FIG. 3 is a sequential diagram illustrating an operation of the mobile communication system according to the first embodiment of the invention.

FIG. 4 is a functional block diagram of a communication application according to Modification 1 of the invention.

FIG. 5 is a sequential diagram illustrating an operation of a mobile communication system according to Modification 1 of the invention.

FIG. 6 is a sequential diagram illustrating an operation of the mobile communication system according to Modification 1 of the invention.

### MODES FOR CARRYING OUT THE INVENTION

### Mobile Communication System According to First Embodiment of the Invention

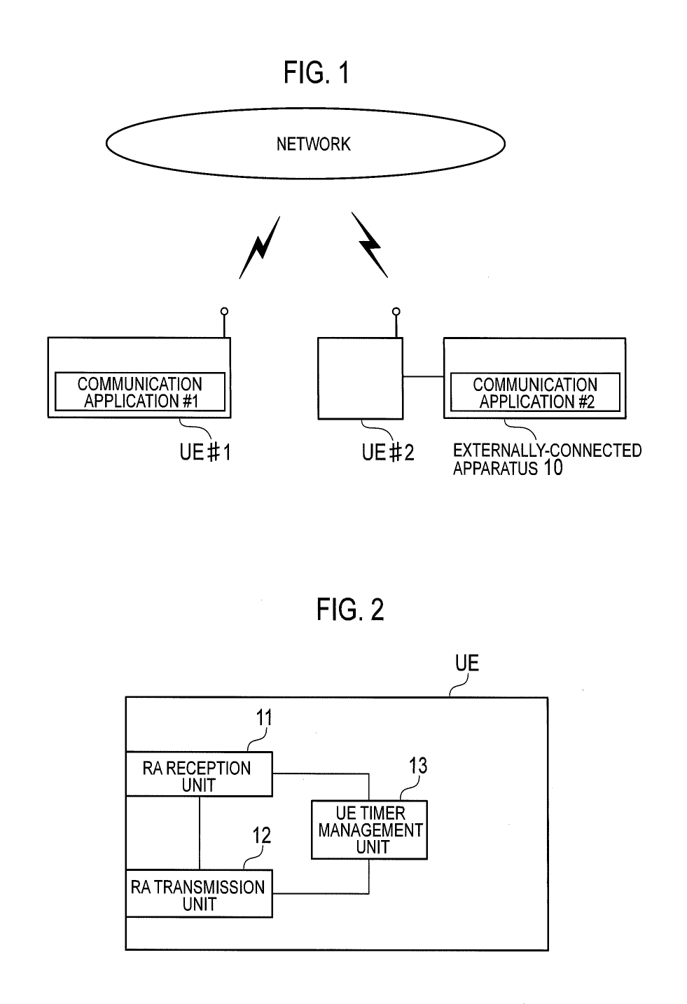

Referring to FIG. 1 to FIG. 3, a mobile communication system according to a first embodiment of the invention is described.

As illustrated in FIG. 1, a mobile communication system according to the embodiment includes a mobile station UE#1 which is activated by a communication application #1 requiring IP routing processing, e.g., a browser or the like and a mobile station UE#2 connecting with an externally-connected apparatus 10 which is activated by the communication application #1 requiring the IP routing processing, e.g., a browser or the like.

For example, the mobile communication system according to the embodiment includes an EPC (Evolved Packet Core) network, as a network, to which PMIPv6 (Proxy Mobile IP) or GTP (GPRS Tunneling Protocol) is applied.

Such a network includes UTRAN (Universal Terrestrial Radio Access Network)/GERAN (GSM EDGE Radio Access Network), SGSN (Serving GPRS Support Node, a packet switch), E-UTRAN (Evolved Universal Terrestrial Radio Access Network), MME (Mobility Management Entity, a mobility management node), S-GW, P-GW connecting with PDN (Packet Data Network), HSS (Home Subscriber Server, a subscriber management server), PCRF (Policy and Charging Rules Function), and the like.

In the mobile communication system according to the embodiment, the network is configured to transmit a “RA” to the mobile station UE#1/UE#2 at an Attach procedure or a PDN connection procedure of at least the mobile station UE#1/UE#2.

Note that in the mobile communication system according to the embodiment, for example, as specified in the 3GPP TS23.402, the S-GW with which the mobile station UE#1/UE#2 is connected is configured to transmit a “RA” containing “default gateway information” to the mobile station UE#1/UE#2 when the “MaxRtrAdvInterval” has expired.

Alternatively, for example, as specified in the 3GPP TS23.401, the P-GW with which the mobile station UE#1/UE#2 is connected may be configured to transmit a “RA” containing “default gateway information” to the mobile station UE#1/UE#2 when the “MaxRtrAdvInterval” has expired.

In addition, in the mobile communication system according to the embodiment, the communication application #1/#2 is configured to set a “Router lifetime” and hold the “default gateway information” contained in a “RA” when a “RA” is received via the mobile station UE#1/#2, and to delete the held “default gateway information” when the “RA” is not re-received before the “Router lifetime” expires.

The mobile station UE#2 according to the embodiment is configured to relay communications between a externally-connected apparatus 10 (i.e., the communication application #2) and the network in a state of being connected with the externally-connected apparatus 10 which is activated by the communication application such as a browser.

As illustrated in FIG. 2, the mobile station UE#1/#2 (hereinafter, a mobile station UE) according to the embodiment includes a RA reception unit 11, a RA transmission unit 12, and a UE timer management unit 13.

The RA reception unit 11 is configured to receive a “RA” from the network, for example, the S-GW or the P-GW with which the mobile station UE is connected.

The RA transmission unit 12 is configured to transmit “RA#1” to the communication application 20 when the RA is received by the RA reception unit 11.

Note that the RA transmission unit 12 is configured to retransmit the “RA” to the communication application 20 even when the “RA” is not re-received by the RA reception unit 11 before the “Router lifetime” in the communication application 20 expires.

The UE timer management unit 13 is configured to manage a UE timer.

Here, the UE timer is set when the “RA” is transmitted by the RA transmission unit 12 to the communication application 20, and is stopped when the “RA” is received by the RA reception unit 11.

In addition, the UE timer is configured to expire in a time period shorter than the “Router lifetime.”

Note that the RA transmission unit 12 is configured to transmit (or retransmit) the “RA” to the communication application 20 when the UE timer is stopped and when the UE timer has expired.

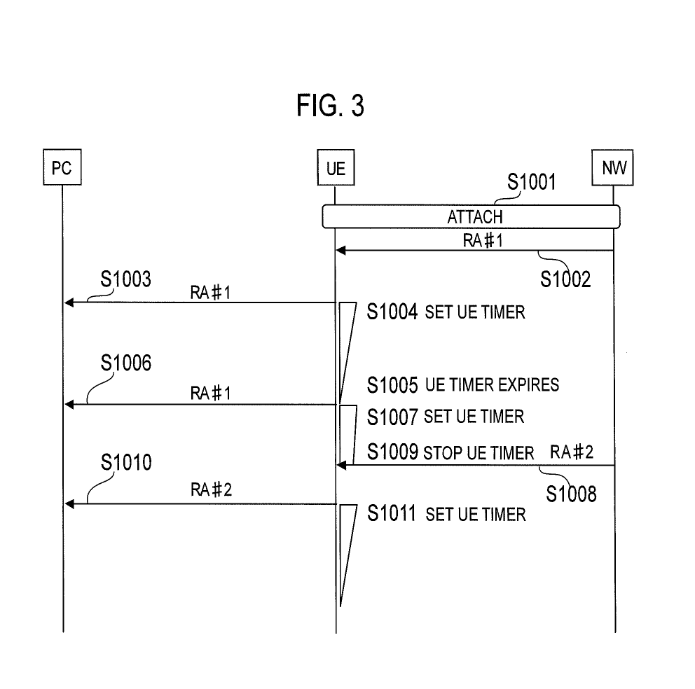

Referring to FIG. 3, an operation of the mobile communication system according to the embodiment is described below.

As illustrated in FIG. 3, at step S1001, the Attach procedure of the mobile station UE is performed, and at step S1002, the network transmits the “RA#1” to the mobile station UE.

At step S1003, the mobile station UE transmits the “RA#1” to the communication application 20, and, at step S1004, sets the UE timer.

Here, the communication application 20 holds the “default gateway information” contained in the “RA” and sets the “Router lifetime.” Hereinafter, the communication application 20 performs packet communications using the held “default gateway information.”

After that, at step S1005, the mobile station UE detects that the UE timer has expired without receiving a new “RA” from the network, and, at step S1006, retransmits the “RA#1” to the communication application 20 and, at step S1007, sets the UE timer.

Here, the communication application 20 updates the held “default gateway information” by the “default gateway information” contained in the “RA#1,” and sets the “Router lifetime.” Hereinafter, packet communications are performed using the updated “default gateway information.”

After that, when the mobile station UE receives a “RA#2” from the network at step S1008, at step S1009, it stops the UE timer, and, at step S1010, transmits the “RA#2” to the communication application 20 and then, at step S1011, sets the UE timer.

Note that the mobile station UE may be configured to retransmit the “RA” previously transmitted to the communication application 20 before the “Router lifetime” in the communication application 20 expires only when a predetermined instruction is made from the network (e.g., such as the P-GW) at the Attach procedure.

In such a case, the P-GW may be configured to make the predetermined instruction to the mobile station UE with PCO (Protocol Configuration Option).

Alternatively, the P-GW may be configured to make the predetermined instruction to the mobile station UE by another method (such as a method of transmitting NAS (Non-Access Stratum) signal via the MME with a signal at the time of Attach or PDN connected state).

Note that such a method is also effective in the S5/S8 network to which the GTP is applied.

In addition, in the S5/S8 to which the PMIP is applied, besides the above-described method, the P-GW may notify the S-GW that the predetermined instruction is made from a PMIP signal, Diameter signal (via PCRF) or the like.

In that case, the S-GW may be configured to set “RA” transmission timing along with the predetermined instruction to the mobile station which is made from the P-GW.

For example, the S-GW may be configured to transmit a “RA” anew without periodically transmitting a “RA” only after the S-GW with which the mobile station UE is connected is changed or only when the mobile station UE transitions from the “IDLE state” to the “ACTIVE state”.

In the mobile communication system according to the embodiment, the mobile station UE receives the “RA” in the “IDLE state,” and thus there is no need for the mobile station UE to be periodically in the “ACTIVE” state. Accordingly, the waste of radio resources or the waste of the battery of the mobile station UE or the externally-connected apparatus 10 can be suppressed.

In addition, in the mobile communication system according to the embodiment, there can be avoided an inconvenience that the communication application 20 cannot transmit packets with frequent switching of the S-GW in the S5/S8 network to which the PMIP is applied.

(Modification 1)

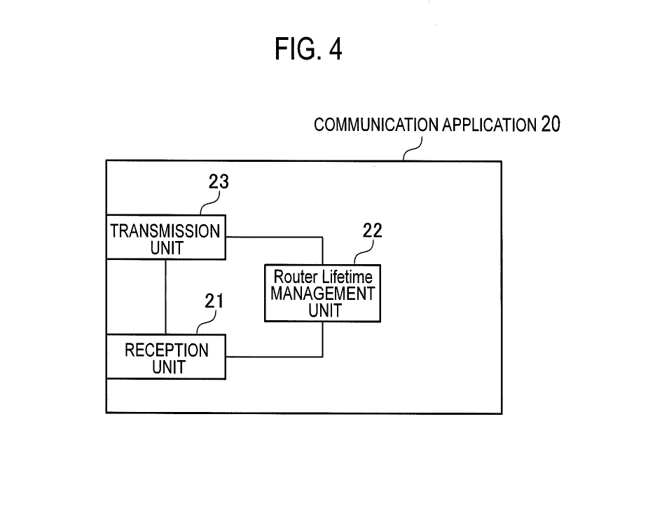

Referring to FIG. 4 to FIG. 6, a mobile communication system according to Modification 1 is described. Hereinafter, a mobile communication system according to Modification 8 is described by paying attention to a difference with the mobile communication system according to the first embodiment.

As illustrated in FIG. 4, a communication application #1/#2 (hereinafter, a communication application 20) which is activated on a mobile station UE #1 or an externally-connected apparatus 10 includes a reception unit 21, a management unit 22, and a transmission unit 23.

The reception unit 21 is configured to receive a “RA” via the mobile station UE.

The management unit 22 is configured to manage “Router lifetime” or “default gateway information.”

Here, the “Router lifetime” is configured to be set when a “RA” is received by the reception unit 21.

Note that the management unit 22 is configured to set the “Router lifetime” and hold the “default gateway information” contained in the “RA” when the “RA” is received by the reception unit 21.

Also, the management unit 22 is configured to delete the held “default gateway information” when a “RA” is not re-received before the “Router lifetime” expires.

The transmission unit 23 is configured to transmit uplink packets via the mobile station UE or the externally-connected apparatus 10.

Note that the transmitter 23 is configured to transmit a packet communication originating request signal to the mobile station UE when the “Router lifetime” has expired even when a packet to be transmitted is absent.

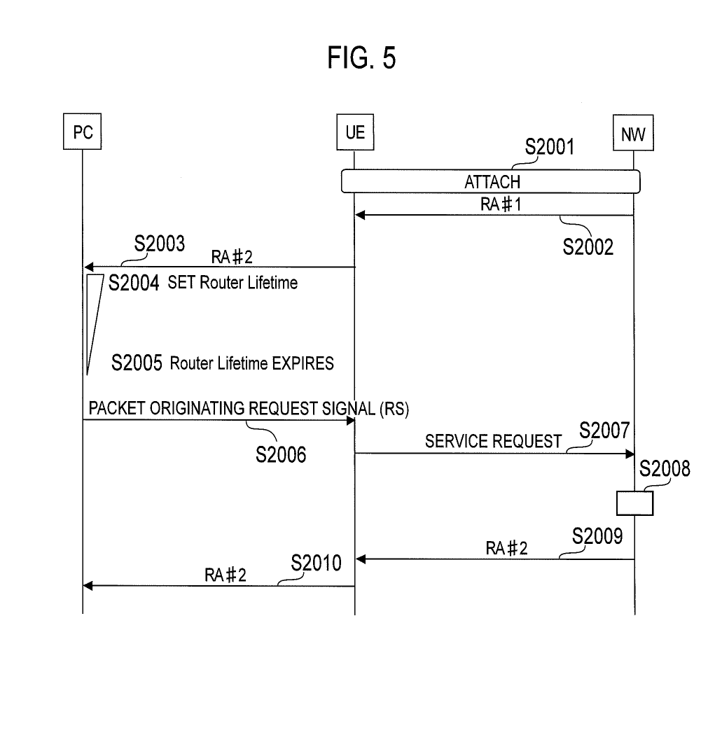

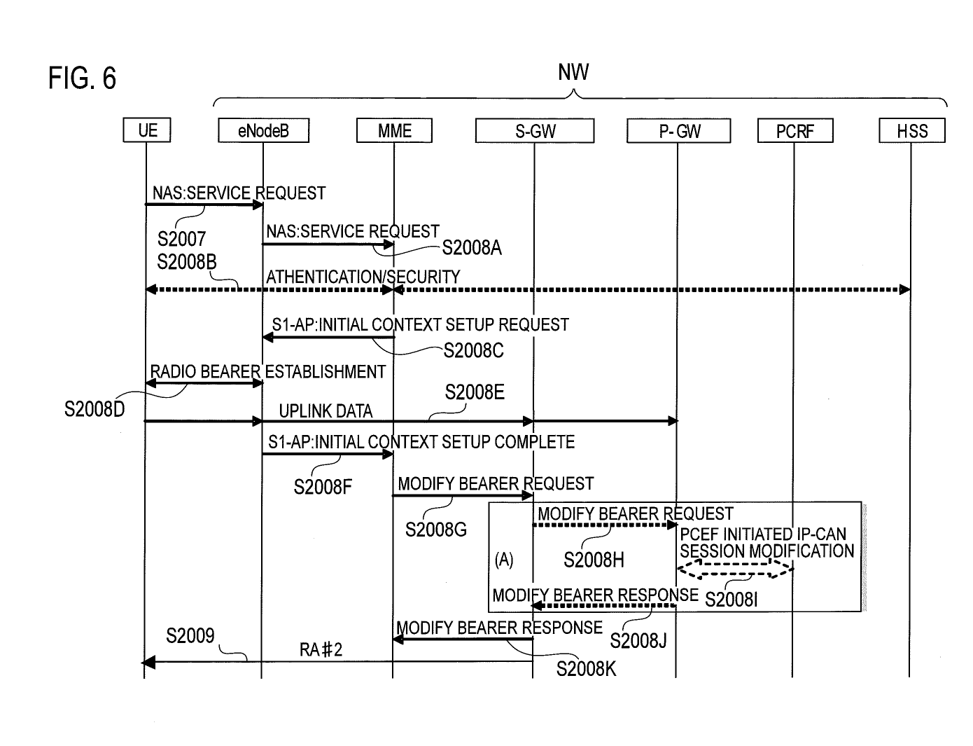

Referring to FIG. 5 and FIG. 6, an operation of the mobile communication system according to Modification 1 is described below.

As illustrated in FIG. 5, at step S2001, Attach procedure of the mobile station UE is performed, and, at step S2002, the network transmits a “RA#1” to the mobile station UE, and, at step S2003, the mobile station UE transmits the “RA#1” to the communication application 20.

Here, the communication application 20 holds the “default gateway information” contained in the “RA#1” and sets the “Router lifetime.” Hereinafter, the communication application 20 performs packet communications using the held “default gateway information.”

Thereafter, at step S2005, the communication application 20 detects that the “Router lifetime” has expired, and, at step S2006, it transmits a packet communication originating request signal (RS: Router Solicitation) to the mobile station UE regardless of whether a packet to be transmitted is present or not.

At step S2007, the mobile station UE transmits “Service Request (Service request signal)” to the mobile station UE in the “IDLE state.”

When the “Service Request” is received, the network performs, for example, “UE triggered Service Request Procedure” which is specified in FIG. 5.3.4.1-1 of the 3GPP TS23.401.

Here, the S-GW checks that “downlink U-Plane address information (S1 eNodeB F-TEID or S4-U SGSN F-TEID)” is set in the “Modify Bearer Request” received at step S2008. Then, after the establishment of the U-Plane, in other words, at step S2009, the S-GW activates “NW Initiated Service Request Procedure” and transmits the “RA#2” to the mobile station UE.

At step S2010, the mobile station UE transmits the received “RA#2” to the communication application 20.

Here, the communication application 20 holds the “default gateway information” contained in the “RA#2” and sets the “Router lifetime.” Hereinafter, the communication application 20 performs packet communications using the held “default gateway information.”

Note that when the predetermined instruction is made from the network (e.g., P-GW) with respect to the mobile station UE, the mobile station UE may be configured to retransmit the “RA#1” previously transmitted to the communication application 20 in response to the packet communication originating request signal at step S2006 without performing the operation at steps S2007 to S2009 in the mobile communication system according to Modification 1.

In the mobile communication system according to Modification 1, when the “Router lifetime” has expired, the communication application 20 is configured to be capable of transmitting the packet communication originating request signal (RS) to the mobile station UE, so that the “RA” can be acquired. Thus, it can avoid the situation that the communication application 20 cannot perform communications.

The features of the embodiment as described above may be expressed as follows.

A first feature of the present embodiment is a mobile station UE capable of communicating with a communication application 20 which is configured to set “Router lifetime (predetermined timer)” and hold “default gateway information (packet transfer information)” contained in a “RA” when the “RA (notification signal)” is received, and to delete the held “default gateway information” when the “RA” is not re-received before the “Router lifetime” expires. The mobile station UE includes: a RA reception unit 11 (notification signal reception unit) configure to receive a “RA” from a network; and a RA transmission unit 12 (notification signal transmission unit) configured to transmit a “RA#1” to the communication application 20 when the “RA#1 (first notification signal)” is received by the RA reception unit 11, in which the RA transmission unit 12 is configured to retransmit the “RA#1” to the communication application 20 even when a “RA#2 (second notification signal)” is not re-received by the RA reception unit 11 before the “Router lifetime” in the communication application 20 expires.

In the first feature of the embodiment, the mobile station UE may include a UE timer management unit 13 (mobile station timer management unit) configured to manage a UE timer (mobile station timer), in which the UE timer may be configured to be set when a “RA” is transmitted by the RA transmission unit 12 to the communication application 20, to be stopped when the “RA” is received by the RA reception unit 11, and to expire in a time period shorter than the “Router lifetime,” and the RA transmitter 12 may be configured to transmit (or retransmit) the “RA” to the communication application 20 when the UE timer is stopped and when the UE timer has expired.

In the first feature of the embodiment, the RA transmission unit 12 may be configured to retransmit the “RA#1” to the communication application 20 before the “Router lifetime” in the communication application 20 expires only when a predetermined instruction is made from the network (e.g., the P-GW).

A second feature of the embodiment is a communication application 20 configured to set “Router lifetime” and hold “default gateway information” contained in a “RA” when the “RA” is received via a mobile station UE, and to delete the held “default gateway information” when the “RA” is not re-received before the “Router lifetime” expires, in which the communication application 20 includes a transmission unit 23 configured to transmit a packet communication originating request signal to the mobile station UE when the “Router lifetime” has expired even when a packet to be transmitted is absent.

A third feature of the embodiment is a mobile communication method in a mobile communication system including a network, a mobile station UE, and a communication application 20, in which the communication application 20 is configured to set “Router lifetime” and hold “default gateway information” contained in the “RA” when a “RA” is received via the mobile station UE, and to delete the held “default gateway information” when the “RA” is not re-received before the “Router lifetime” expires, the mobile communication method including: a step of transmitting, by the communication application 20, a packet communication originating request signal to the mobile station UE when the “Router lifetime” has expired even when a packet to be transmitted is absent; a step of transmitting, by the mobile station, “Service Request (service request signal)” to the network in an “IDLE state; ” a step of transmitting, by the network, the “RA” to the mobile station UE in response to the “Service Request;” and a step of transmitting, by the mobile station UE, the received “RA” to the communication application 20.

Note that the above described operations of the mobile station UE, the communication application 20, and the like may be implemented by hardware, may be implemented by a software module executed by a processor, or may be implemented by a combination of both.

The software module may be provided in any type of storage medium such as an RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can read and write information from and to the storage medium. Also, the storage medium may be integrated into the processor. Also, the storage medium and the processor may be provided in an ASIC. The ASIC may be provided in the mobile station UE and the like. Also, the storage medium and the processor may be provided in the mobile station UE and the like as a discrete component.

The present invent has been described in detail by using the embodiment. However, it is obvious to those skilled in the art that the present invention is not limited only to the embodiment described in this specification. The present invention can also be implemented as modified and altered aspects without departing from the gist and scope of the invention to be defined by the appended claims. Thus, the description of the specification is intended merely for describing examples and does not impose any limitations to the present invention.

Note that the entire content of Japanese Patent Application No. 2011-026584 (filed on Feb. 9, 2011) is incorporated herein by reference.

### INDUSTRIAL APPLICABILITY

As described above, the present invention can provide a mobile station, a communication application, and a mobile communication method, in which the communication application is caused to be capable of receiving a “RA” before “Router lifetime” expires while avoiding the waste of radio resources, the waste of the battery of the mobile station UE or an externally-connected apparatus, or network processing required for transition of the mobile UE between an “IDLE state” and an “ACTIVE state”.

### EXPLANATION OF THE REFERENCE NUMERALS

UE mobile station
11 RA reception unit
12 RA transmission unit
13 UE timer management unit
10 externally-connected terminal
20 communication application
21 reception unit
22 management unit
23 transmission unit

1. A mobile station capable of communicating with a communication application configured to set a predetermined timer and hold packet transfer information contained in a notification signal when the notification signal is received, and to delete the held packet transfer information when a notification signal is not re-received before the predetermined timer expires, the mobile station comprising:
a notification signal reception unit configured to receive a notification signal from a network; and
a notification signal transmission unit configured to transmit a first notification signal to the communication application when the first notification signal is received by the notification signal reception unit, wherein
the notification signal transmission unit is configured to retransmit the first notification signal to the communication application even when a second notification signal is not re-received by the notification signal reception unit before the predetermined timer in the communication application expires.

2. The mobile station according to claim 1, comprising a mobile station timer management unit configured to manage a mobile station timer, wherein
the mobile station timer is configured to be set when a notification signal is transmitted by the notification signal transmission unit to the communication application, to be stopped when a notification signal is received by the notification signal reception unit, and to expire in a time period shorter than the predetermined timer, and
the notification signal transmission unit is configured to transmit a notification signal to the communication application when the mobile station timer is stopped and when the mobile timer has expired.

3. The mobile station according to claim 1, wherein the notification signal transmission unit is configured to retransmit the first notification signal to the communication application before the predetermined timer in the communication application expires only when a predetermined instruction is made from the network.

4. A communication application configured to set a predetermined timer and hold packet transfer information contained in a notification signal when the notification signal is received via a mobile station, and to delete the held packet transfer information when a notification signal is not re-received before the predetermined timer expires, the communication application comprising:
a transmission unit configured to transmit a packet communication originating request signal to the mobile station when the predetermined timer has expired even when a packet to be transmitted is absent.

5. A mobile communication method in a mobile communication system including a network, a mobile station, and a communication application, in which the communication application is configured to set a predetermined timer and hold packet transfer information contained in a notification signal when the notification signal is received via a mobile station, and to delete the held packet transfer information when a notification signal is not re-received before the predetermined timer expires, the mobile communication method comprising:
a step A of transmitting, by the communication application, a packet communication originating request signal to the mobile station when the predetermined timer has expired even when a packet to be transmitted is absent;
a step B of transmitting, by the mobile station, a service request signal to the network in an idle state;
a step C of transmitting, by the network, a notification signal to the mobile station in response to the service request signal; and
a step D of transmitting, by the mobile station, the received notification signal to the communication application.

6. The mobile station according to claim 2, wherein the notification signal transmission unit is configured to retransmit the first notification signal to the communication application before the predetermined timer in the communication application expires only when a predetermined instruction is made from the network.
